(19) United States
(12) Patent Application Publication
(10) Pub. No.: US 2001/0014900 A1
(43) Pub. Date: Aug. 16, 2001

(54) Method and system for separating content and layout of formatted objects

(75) Inventors: Michael Brauer, Hamburg (DE); Matthias Breuer, Seevetal (DE); Christian Lippka, Hohenfelde (DE)

Correspondence Address: Phiip McKay, Gunnison, McKay & Hodgson, L.L.P., Garden West Office Plaza, Suite 220, 1900 Garden Road, Monterey, CA, 93940, US

(73) Assignee: Sun Microsystems, Inc.

(21) Appl. No.: 09/782,899

(22) Filed: Feb. 13, 2001

(30) Foreign Application Priority Data
Feb. 16, 2000 (EP) 000103172.3

(51) Int. Cl. G06F 15/00

(52) U.S. Cl. 707/513; 707/517

(57) ABSTRACT

A method for separating content and layout of formatted data objects to convert a computer readable document into a structured mark-up document. A computer readable document containing content data and formatting data is converted into an XML-document whereby the content data and formatting data are separated and are arranged as separate elements in the XML-document. The computer readable document contain first formatting data which are directly assigned to a formatted object and second formatting data contained in a separate formatting template. On the XML-document, the first formatting data are then arranged in a formatting element and the second formatting data in a parent formatting element referring back to the child formatting element.

### FIELD OF THE INVENTION

The present invention relates a method for separating content and layout of formatted data objects to convert a computer readable document into a structured mark-up document such as an XML-document.

### BACKGROUND OF THE INVENTION

Within a short time after its standardization, the Extended Mark-up Language, hereinafter referred to as XML, has become increasingly popular among software developers for world-wide-web applications. Consequently, XML is on its way to becoming a worldwide standard for the creation of structured web based documents.

XML can is a meta-language for describing mark-up languages and provides facilities to define tags and the structural relationships between them. In contrast to the older HyperText Mark-up Language (HTML), with XML, there is not a predefined tag set and consequently, there are no preconceived semantics. All of the semantics of an XML-document will either be defined by the applications that process them or by style sheets, i.e., formatting templates.

Among the advantages of XML is the fact that XML has a higher flexibility than HTML but also enjoys a universal compatibility. In addition, XML-documents are relatively easy to create and, to a certain extent, are human-legible. XML is well known to those of skill in the art and a more detailed discussion of XML, and its numerous attributes and advantages, can be found in publicly available sources such as those published by Norman Walsh on Oct. 3, 1998 under www.xml.com and in the book “Mastering XML” by Ann Navarro, Chuck White and Linda Burman, published by SYBEX, 1997, ISBN: 0-7821-2266-3, Library of Congress Card Number 98-86255. Consequently, a detailed discussion of XML is not included herein to avoid detracting from the present invention.

As is well known in the art, the objects contained in structured computer readable documents have certain assigned formatting properties. For example, these objects can include document pages, paragraphs, text portions, tables, images, mathematical formula, 3D graphics, etc. The formatting properties define attributes such as character size and style, the distance between paragraphs and lines, positioning on the document and other format related items.

It is also well known to those of skill in the art that there are typically two different ways of assigning formatting properties to an object, first by assigning a style sheet or formatting template to the object or, secondly, by assigning the formatting properties to the object directly.

In the first case, where a style sheet or formatting template is assigned, the formatting template that defines text formatting properties is applied to a text portion, such as a paragraph. The formatting template then defines the formatting properties of the whole text portion.

In the second case, where the formatting properties are assigned directly to the object, a format is defined for a selected document portion by the user specifically choosing the text formatting properties, such as character size and style, paragraph properties, etc. In these instances, the user chooses the text formatting by employing a user interface such as a keyboard or mouse.

It is also known to use a formatting template in the role of master or “parent” formatting template for dependent or “child” formatting templates. In these systems, the dependent formatting template refers to the parent formatting template and uses all the formatting properties defined therein. However, the dependent formatting template additionally defines new properties or amends some of the properties of the parent formatting template.

For example, a parent formatting template might be designated “headline 1” and “headline 1” might include a set of several formatting properties including a certain character size. A dependent format “headline 2” might use all of the formatting properties of “headline 1” with the exception of the character size. In this example, dependent format “headline 2” could have a character size that is either enlarged or reduced compared with “headline 1”, however, all of the other formatting properties of the set of several formatting properties making up “headline 1” are included in “headline 2” and are identical to those used in “headline 1”. Consequently, by making “headline 2” a dependent format with respect to “headline 1” there is no need to re-create the format from scratch and the redundancy of formatting properties is exploited.

In addition to the parent-child formatting procedures discussed above, it is also possible to use a formatting template and then directly, or “hard”, assign some properties of particular parts of the formatted object within the format.

In an XML-document, the style of every object contained in the XML-document might be represented by a style element. The formatting properties of the object are then contained in the style element, either as XML attributes or as separate XML elements. When converting a non-XML-document, like a text document containing hard formatting attributes, the hard or direct formatting properties must be converted into style attributes of the respective XML element and the formatting templates must be converted into separate XML elements. This is illustrated in the following example.

### EXAMPLE A

(1.0) <style:style style:name=“text body” style:parent-style-name=“Standard”>

(1.1) <!—This is the definition of a style with name “text body”—>

(1.2) <!—The style's parent style is a style with name “Standard”—>

(1.3) <!—The style has a formatting property assigned that—>

(1.4)<!—displays text using a bold front—>

(1.5) <style: properties fo: font-weight=“bold”>

(1.6) </style: style>

(2.0) <text: p style: style-name-“text body”>

(2.1) <style: properties fo: font-style=“italic”/>

(2.2) This paragraph is displayed using an italicised bold font.

(2.3) </text: p>

In Example A, the first paragraph, lines 1.0 to 1.6, represents an XML element defining a particular style named “text body”, which is based on the parent style “Standard”. The style “text body” displays the text using the properties defined by the parent style “Standard” and, in addition to the properties defined by the parent style “Standard”, a bold font. This XML element is the XML counterpart of a formatting template.

In the second paragraph in Example A, lines 2.0 to 2.3, the text “This paragraph is displayed using an italicised bold font”, and refers to the first XML element defining the style “text body” that additionally contains a style property as an attribute, i.e., that the font style should be “italic”. The attribute is the XML counterpart of a hard formatting property.

This prior art XML representation of documents containing formatting properties has the disadvantage that content and layout are mixed in the XML representation as in the second XML element in paragraph 2. This is generally undesirable, and is particularly problematic if in the XML-document only the content or the style has to be edited and changed.

What is needed is a method that provides an XML representation of a computer readable document containing hard formatting properties where the content and style properties of the XML-document are easily amended.

### SUMMARY OF THE INVENTION

One embodiment of the present invention is a method for separating content and layout of formatted data objects to convert a computer readable document into a structured mark-up document such as an XML-document. In accordance with the present invention, an XML representation of a computer readable document contains hard formatting properties and the content and style properties of the XML-document are easily amended. The method of the invention allows for conversion of a computer readable document containing content data and formatting data into a structured mark-up document. One embodiment of the invention includes separating the content data from the formatting data and arranging the content data and the formatting data as separate elements of the structured mark-up document.

The method of the present invention allows a separation of content data and formatting data on the mark-up document, which is highly desirable with regard to amending and/or editing the document. In one embodiment of the invention, the mark-up document is an XML-document. In other embodiments of the invention, other document types and file formats, such as Standard Generalized Mark-up Language (SGML) may also be possible.

According to one embodiment of the present invention, the document to be converted contains first formatting data which are directly assigned to a formatting object and second formatting data contained in a separate formatting template. In the XML-document, the first formatting data are included in a formatting element, the child formatting element, and the second formatting data are included in a parent formatting element. The formatting element, i.e., the child formatting element, then makes reference to the parent formatting element. According to one embodiment of the invention, the hard formatting properties of the original document are thus converted into an XML formatting element, the child formatting element, and a formatting template is converted into a parent formatting element, to which the child formatting element refers. A parent formatting template on the original document consequently becomes a “grandparent” formatting element in the XML-document.

According to one embodiment of the invention, if a particular style is used by many objects, a plurality of content elements and/or formatting elements may refer to the same formatting element, i.e., the child formatting element, thus reducing the overall volume of the XML-document.

According to one embodiment of the invention, a formatting element of the XML-document may be assigned an identifier, such as a flag, indicating that the formatting data are obtained by conversion of hard formatting data. Consequently, a re-conversion into directly assigned (hard formatted) style properties is possible.

A further implementation of the present invention provides a computer system for converting a computer readable document containing content data and formatting data into an XML-document having program code for separating the content data from the formatting data and for arranging the content data as content elements and the formatting data as separate formatting elements in the XML-document.

A still further implementation of the present invention provides a computer program for converting a computer readable document containing content data and formatting data into an XML-document including program code adapted for separating content data from formatting data and for arranging the content data and formatting data as separate elements in the XML-document.

According to one embodiment of the invention, the program code may be embodied in any form of a computer program product. A computer program product includes a medium which stores or transports computer readable code, or in which computer readable code may be embedded. Some examples of computer program products are: CD-ROM discs; ROM cards; floppy discs; magnetic tapes; computer hard drives; servers on a network; and signals transmitted over a network representing a computer readable program code.

A still further implementation of the present invention provides a storage medium including: first data elements containing content data represented in XML code; second data elements containing formatting data obtained by converting formatting data contained in a formatting template in a computer readable document represented in XML code; and third data elements containing formatting data obtained by converting formatting data directly assigned to objects contained in the computer readable document represented in XML code.

One advantage of the present invention is that content data and formatting data are separated on the XML-document. This is true irrespective of the type of format assignment used in the original document. Consequently, embodiments of the invention provide that amendments of the style and/or the content of the XML-document can be carried out easily. This greatly improves the utility of the XML-document.

Moreover, a first formatting element may be employed by a plurality of other formatting elements (the first formatting element thus being parent formatting elements) or content elements. The overall document size can therefore be reduced and efficiency increased.

These and other features and advantages of the present invention will be more readily apparent from the detailed description set forth below taken in conjunction with the accompanying drawings.

### BRIEF DESCRIPTION OF THE DRAWINGS

FIG. 1A is a schematic illustration of one embodiment of a computer system and a client-server configuration employing one embodiment of the present invention.

FIG. 1B is a flow chart illustrating one embodiment of the present invention.

FIG. 2 is a flow chart illustrating part of a second embodiment of the present invention.

FIG. 3 is a schematic illustration of a document to be converted using the method of the invention and the resulting XML-document according to one embodiment of the present invention.

FIG. 4 is a flow chart illustrating a further embodiment of the present invention.

FIG. 5A illustrates a memory 500 being used to store XML elements in accordance with one embodiment of the invention.

FIG. 5B illustrates a memory 500 being used to store XML elements in accordance with one embodiment of the invention.

FIG. 5C illustrates a memory 500 being used to store XML elements in accordance with one embodiment of the invention.

FIG. 5D illustrates a memory 500 being used to store XML elements in accordance with one embodiment of the invention.

In the following description, similar elements are labeled with similar reference numbers.

### DETAILED DESCRIPTION

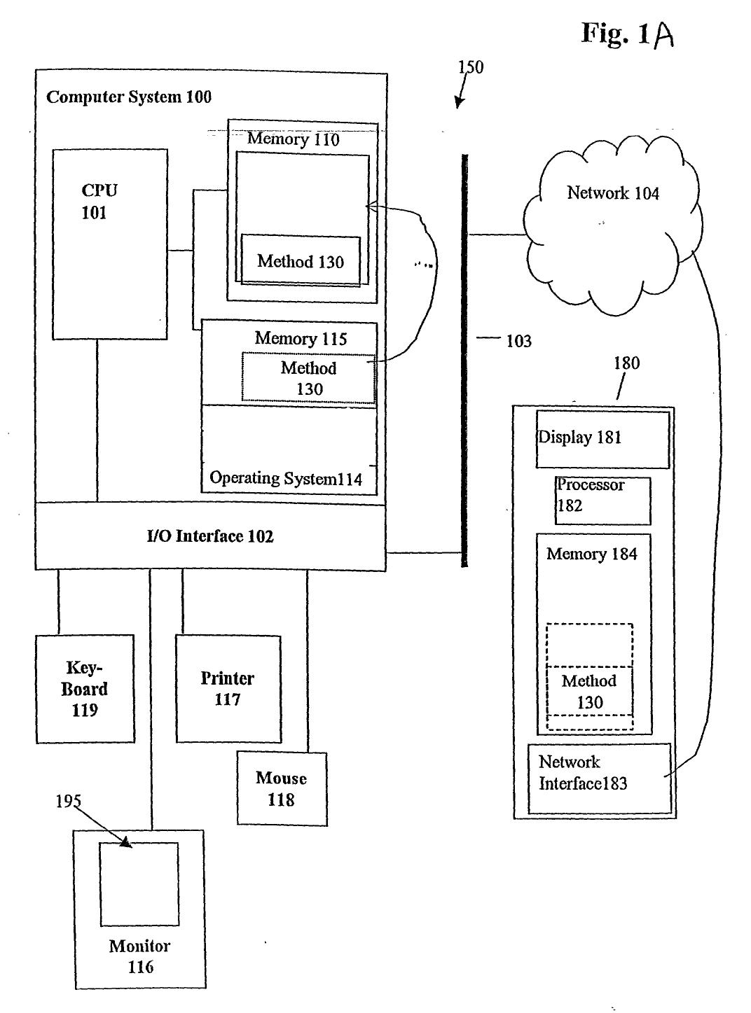

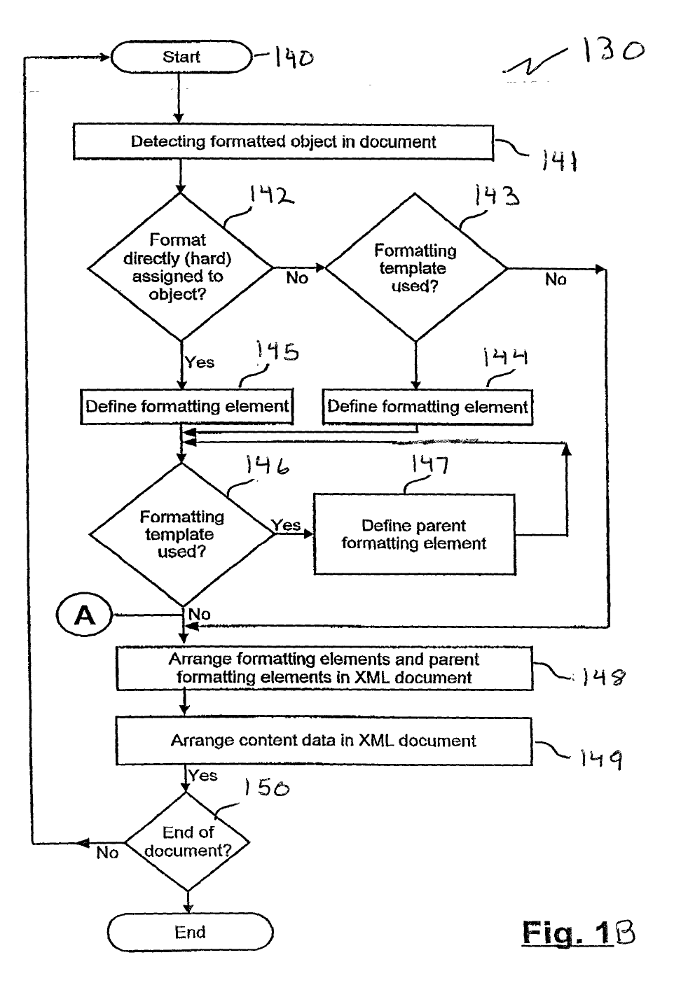

As seen in FIG. 1A, in one embodiment of the present invention, a computer system 100, such as a personal computer, includes: a CPU or processor 101; a first level memory 110 including at least a portion of method 130; a second level memory 115, also including at least a portion of method 130, and an operating system 114; and an input/output (I/O) interface 102.

Computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130, or at least can provide the input instructions to method 130, that is executed on another system. Similarly, in another embodiment, computer system 100 can be comprised of multiple different computers, wireless devices, cellular telephones, digital telephones, two-way pagers, or personal digital assistants, server computers, or any desired combination of these devices that are interconnected to perform method 130.

In one embodiment of the invention, a monitor 116 is coupled to I/O interface 102 and computer system 100. Monitor 116 typically includes a display screen 195, which is typically a CRT, flat panel display or the like. Also coupled to I/O interface 102, and computer system 100, are user interfaces, such as keyboard 119 and mouse 118, as well as printer 117.

According to one embodiment of the invention, Method 130 can be executed on a hardware configuration like a personal computer or workstation, as illustrated schematically in FIG. 1A by computer system 100. Method 130, however, may also be applied to a client-server configuration 150 that also is illustrated in FIG. 1A. The source and target documents may be displayed on a display screen of the client device, such as display screen 195 of monitor 116, while some or all operations of method 130 are carried out on a server computer 180 accessible by a client device, such as computer system 100, over a data network 104, or networks 103 and 104, such as the Internet, using a browser application or the like.

Herein, a computer program product comprises a medium configured to store or transport computer readable code for method 130 or in which computer readable code for method 130 is stored. Some examples of computer program products are CD-ROM discs, ROM cards, floppy discs, magnetic tapes, computer hard drives, servers on a network and signals transmitted over a network representing computer readable program code.

As illustrated in FIG. 1A, this storage medium may belong to computer system 100 itself, such as second level memory 115. However, the storage medium also may be removed from computer system 100. For example, method 130 may be stored in memory 184 that is physically located in a location different from processor 101 and computer system 100. The only requirement is that processor 101 is coupled to the memory containing method 130. This could be accomplished in a client-server system 150, e.g. computer system 100 is the client and server computer 180 is the server, or alternatively via a connection to another computer (not shown) via modems and analog lines, or digital interfaces and a digital carrier line.

For example, memory 184 could be in a World Wide Web portal, while monitor 116 and processor 101 are in a personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

In view of this disclosure, method 130 can be implemented in a wide variety of computer system configurations. In addition, method 130 could be stored as different modules in memories of different devices. For example, method 130 could initially be stored in a server computer 180, and then as necessary, a module of method 130 could be transferred to a client device, such as computer system 100, and executed on the client device. Consequently, part of method 130 would be executed on server processor 182, and another part of method 130 would be executed on processor 101 of a client device, such as computer system 100. In view of this disclosure, those of skill in the art can implement the invention on a wide-variety of physical hardware configurations using an operating system and computer programming language of interest to the user. For example, FIG. 1A shows input devices 119 and 118, but other input devices, such as speech recognition software and/or hardware could be used to input the selections and data for method 130.

In yet another embodiment, method 130 is stored in memory 184 of system 180. Stored method 130 is transferred, over network 104 to memory 110 in system 100. In one embodiment, network interface 183 and I/O interface 102 would include analog modems, digital modems, or a network interface card. If modems are used, network 104 includes a communications network, and method 130 is downloaded via the communications network.

Method 130 of the present invention may be implemented in a computer program including a comprehensive STAROFFICE office application that is available from Sun Microsystems, Inc. of Palo Alto, Calif. (STAROFFICE is a trademark of Sun Microsystems.) Such a computer program may be stored on any common data carrier such as, for example, a floppy disk or a compact disc (CD), as well as on any common computer system's storage facilities such as hard disks. Therefore, one embodiment of the present invention also relates to a data carrier for storing a computer program for carrying out the inventive method. Another embodiment of the present invention also relates to a method for using a computer system for carrying out the presented inventive method. Yet another embodiment of the present invention further relates to a computer system with a storage medium on which a computer program for carrying out the presented inventive method is stored.

In accordance with the present invention, using method 130, an XML representation of a computer readable document contains hard formatting properties and is relatively easy to amend in content as well as the style properties of the XML-document. Method 130 allows for conversion of a computer readable document containing content data and formatting data into a structured mark-up document. One embodiment of method 130 of the invention includes separating the content data from the formatting data and arranging the content data and the formatting data as separate elements of the structured mark-up document.

One embodiment of method 130 allows a separation of content data and formatting data on the mark-up document, which is highly desirable with regards to amending and/or editing the document. In one embodiment of method 130, the mark-up document is an XML-document.

As discussed in more detail below, according to one embodiment of method 130, the document to be converted contains first formatting data which are directly assigned to a formatting object and second formatting data contained in a separate formatting template. In the XML-document, the first formatting data are included in a formatting element, i.e., the child formatting element, and the second formatting data are included in a parent formatting element. The formatting element, i.e., the child formatting element, then makes reference to the parent formatting element. According to one embodiment of method 130, the hard formatting properties of the original document are thus converted into an XML formatting element, the child formatting element, and a formatting template is converted into a parent formatting element, to which the child formatting element refers. A parent formatting template on the original document consequently becomes a “grandparent” formatting element in the XML-document.

According to one embodiment of method 130, if a particular style is used by many objects, a plurality of content elements and/or formatting elements may refer to the same formatting element, i.e., the child formatting element, thus reducing the overall volume of the XML-document and increasing efficiency.

According to one embodiment of method 130, a formatting element of the XML-document may be assigned an identifier, such as a flag, indicating that the formatting data are obtained by conversion of hard formatting data. Consequently, a re-conversion into directly assigned (hard formatted) style properties is possible.

One advantage of method 130 is that content data and formatting data are separated on the XML-document that results from the conversion procedure. This is true irrespective of the type of format assignment used in the original document. Embodiments of method 130 provide that amendments of the style and/or the content of the XML-document can be carried out easily. This greatly improves the utility of the XML-document.

Moreover, using one embodiment of method 130, one formatting element may be employed by a plurality of other formatting elements (the former thus being parent formatting elements) or content elements. The overall document size can therefore be reduced.

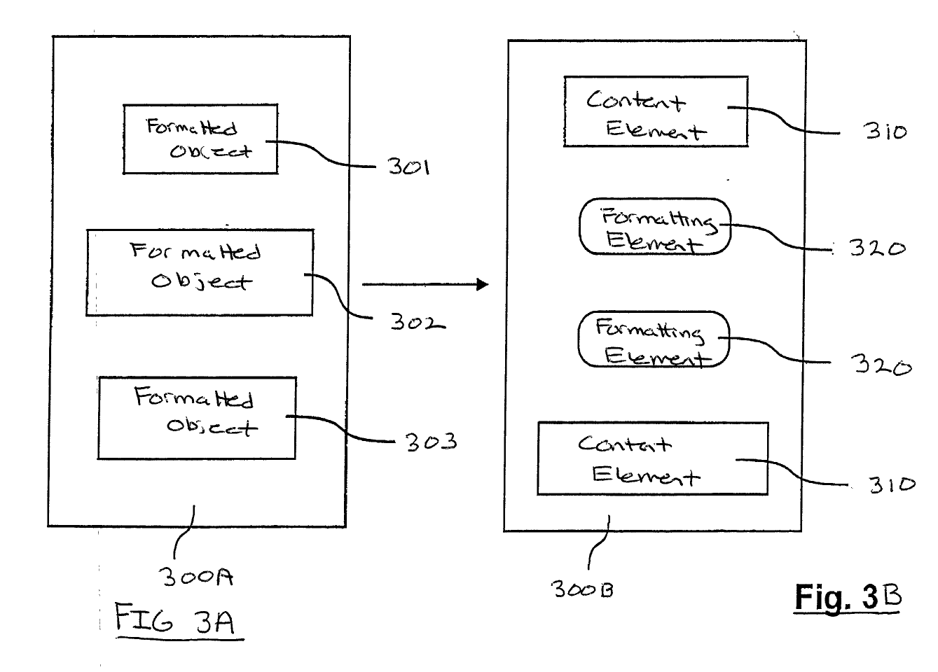

The flow chart of FIG. 1B schematically illustrates one embodiment of method 130 according to the present invention. At 140, method 130 starts. At 141, a formatted object in the computer readable document, which has to be converted into an XML-document, is detected. FIG. 3A shows a schematic illustration of such a computer readable document 300A. The document contains a plurality of formatted objects 301, 302, 303. The format of an object may contain hard (or direct) formatting properties or may alternatively be wholly defined by a formatting template. Any formatting template may refer back to a parent formatting template.

Referring again to FIG. 1B, at 142 method 130 checks whether or not the object detected in 141 contains formatting features, which are directly (hard) assigned to the object. If this is the case, a formatting element is defined at 145, as discussed in more detail below. If, on the other hand, the result at 142 is NO, i.e., the object detected at 141 does not contain formatting features that are directly (hard) assigned, then at 143, method 130 checks whether or not a formatting template is used for assigning the format to the object detected at 141. If the answer is YES, a formatting element corresponding to the formatting template is created at 144.

Method 130 then proceeds to check whether a (further) formatting template is assigned to the object to be converted at 146. If this is the case, the formatting template will form a parent formatting element in the XML-document (147). According to one embodiment of method 130, the process performed at 146 and 147 is subsequently repeated for each additional parent formatting template of the current object, the formatting element generated at 147 then being a grandparent (etc.) formatting element.

When all formatting templates of the current object have been processed, method 130 proceeds to 148 in which the formatting elements and parent formatting elements are arranged in the XML-document. Subsequently, at 149, the content data are arranged in the XML-document separate from the format elements. According to one embodiment of method 130, the order of performance of 148 and 149 is not important, i.e., the formatting elements can also be arranged in the XML-document after the content elements.

At 150, it is determined whether the last object of the document to be converted has been processed or not. In the latter case, i.e., the last object of the document to be converted has not been processed, method 130 returns to 141 and detects the proceeding formatted object. Otherwise, the conversion operation is finished and the completed XML-document may be displayed on a display screen or stored in a suitable memory device.

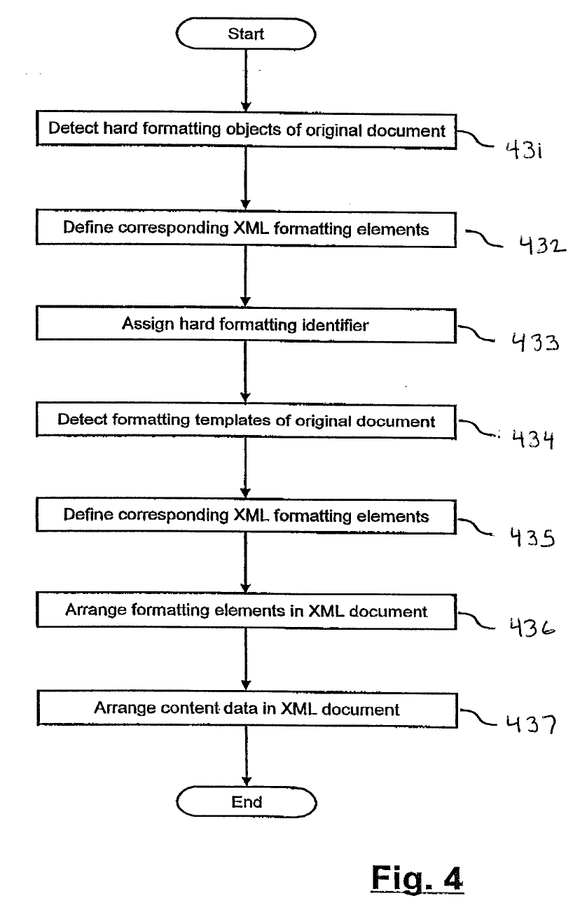

Alternatively, according to one embodiment of method 130, instead of detecting the templates and hard formatting properties of every object and defining the respective XML formatting elements for every object, it is also possible to detect and convert all templates and then all hard formatting properties of the whole document. This embodiment of method 130 is illustrated in FIG. 4. In FIG.4, at 431, all hard formatting objects of the original document to be converted are detected. At 432, corresponding XML formatting elements of the detected hard formatting objects are defined. At 433, a hard formatting identifier is assigned to each of the XML formatting elements.

At 434, the formatting templates, including parent formatting elements, grandparent formatting elements and the like, of the original document are detected and the corresponding XML formatting elements are then created at 435. As in the embodiment of method 130 described above in connection with FIG. 1B, the formatting elements and the content data are then arranged in the XML-document at 436 and 437.

The finished XML-document is schematically represented in FIG. 3B. In FIG. 3B the XML-document as a whole is designated by numeral 300B containing content elements 310 and separate formatting elements 320.

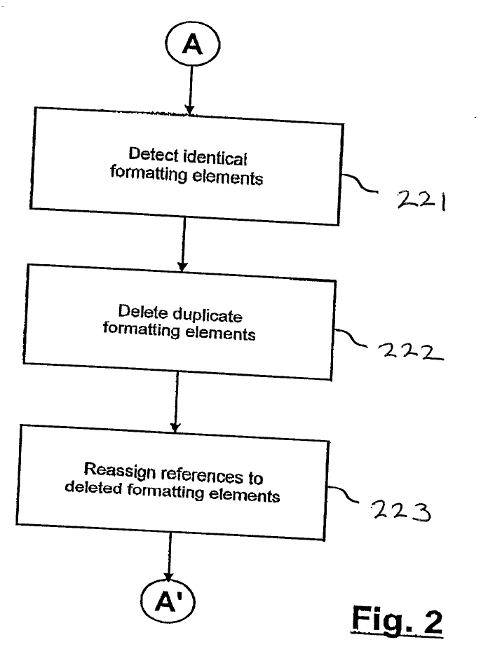

A further embodiment of method 130 is illustrated in FIG. 2. In the embodiment of method 130 shown in FIG. 2, three additional procedures 221, 222 and 223 are carried out at point A in the flow chart of FIG. 1B. At 221, multiple identical formatting elements are detected and duplicate formatting elements are subsequently deleted at 222. Then, at 223, the references to the deleted formatting elements are reassigned to the remaining one of the detected identical formatting elements. With the embodiment of method 130 shown in FIG. 2, unnecessary duplicate formatting elements can be avoided in the XML-document. Therefore, the XML-document size is reduced.

The operation of defining a formatting element or a parent formatting element according to one embodiment of the invention is now described using Example A as discussed above.

The original document to be converted into an XML-document contains, as an object, a text paragraph reading:

(3.1) This paragraph is displayed using an italicised bold font.

In (3.1) above, as in (1.0) to (2.3) of Example A, it is assumed that the style of the paragraph is defined by a parent formatting template called “Standard”, a formatting template called “text body” and the hard formatting property “italic letters”.

In the XML-document this paragraph is represented in Example B as follows:

### EXAMPLE B

(4.0) <style.style style: name=“text body” style: parent-style-name=“Standard”>

(4.1) <style: properties fo: font-weight=“bold”/>

(4.2) </style: style>

(4.3) <style: style style: name=“P1” style: parent-style-name=“text body”>

(4.4) <style: properties fo: font-style=“italic”/>

(4.5) </style: style>

(4.6) <text: p style: style-name=“P1”>

(4.7) This paragraph is displayed using an italicised bold font.

(4.8) </text: p>

In Example B, the base XML element, 4.0 to 4.2, defines the style “text body” employing the parent style “Standard” not shown in the example.

The next XML element, 4.3 to 4.5, defines the style “P1” employing a style “text body” as parent style. Consequently, “Standard” now becomes a grandparent style. The style “P1” defines, in addition to the properties of “text body”, that the font style should be italic.

The last XML element, 4.6 to 4.8, in Example B is the content element, which does not contain any style attributes. The style is fully defined by reference to the formatting template with the name “P1”. Content and formatting properties are thus separated.

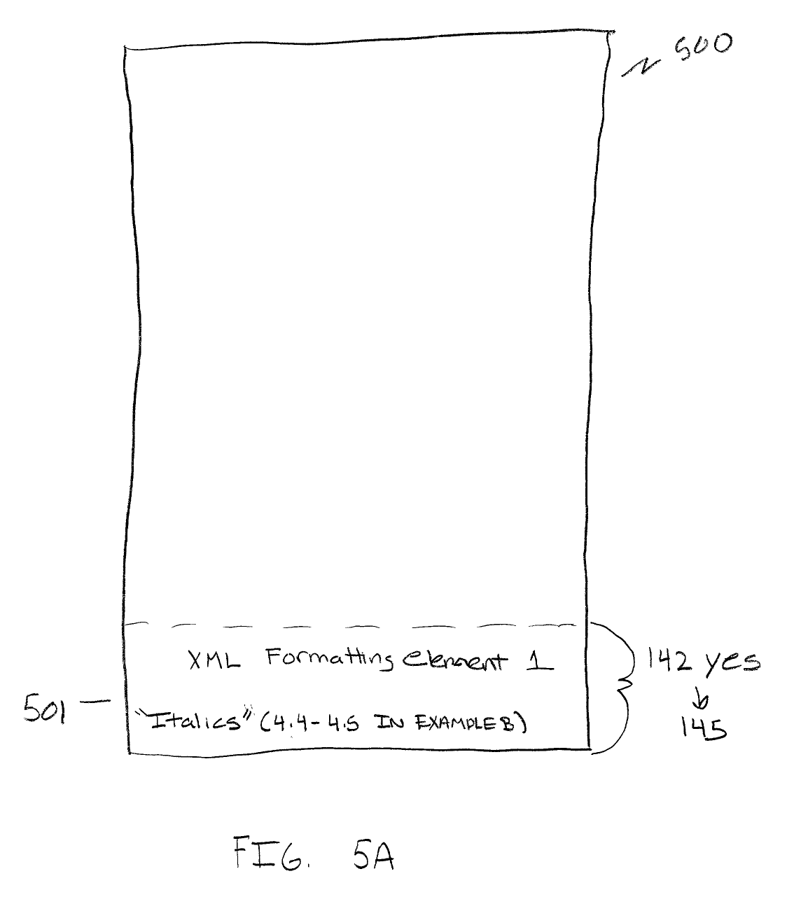

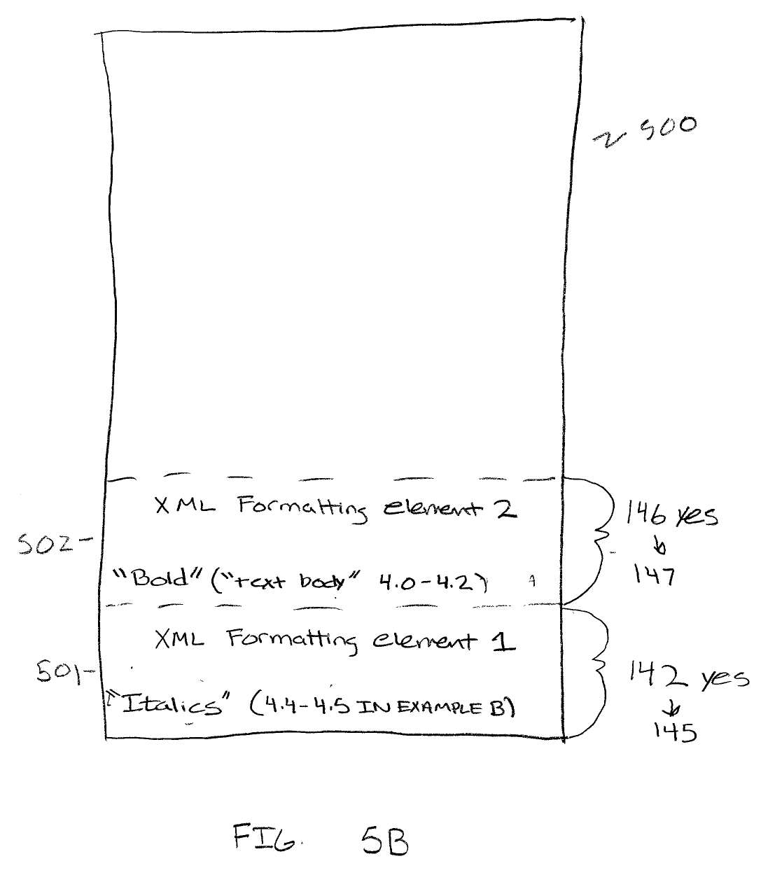

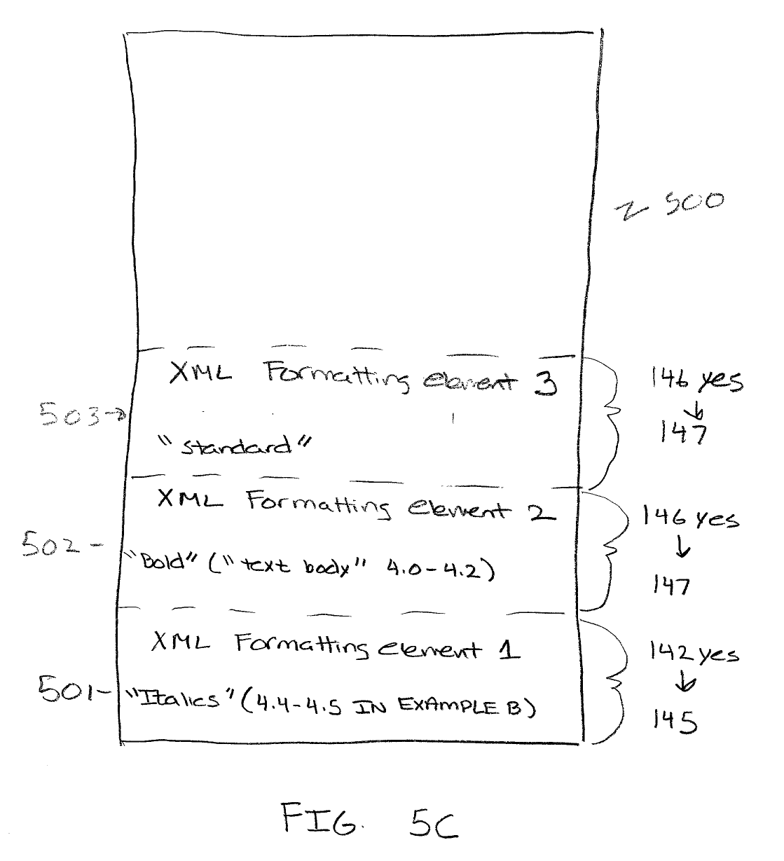

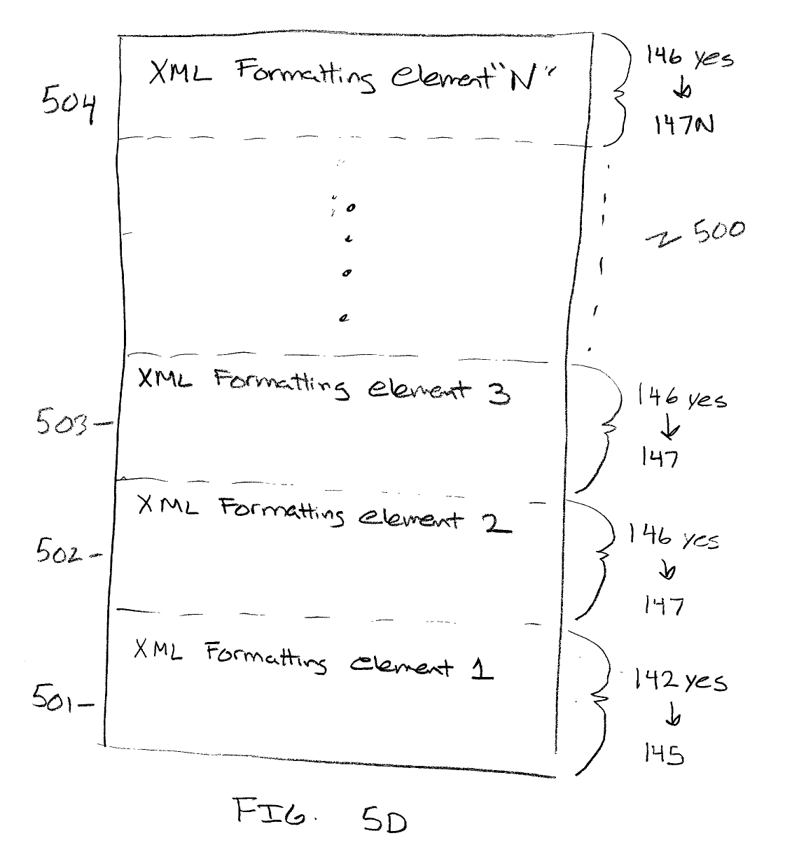

FIGS. 5A, 5B, 5C, and 5D, illustrate a memory 500 being used to store XML elements in accordance with one embodiment of the invention. In one embodiment of the invention, memory 500 is a stack-based memory, however, other memory architectures and types can be used. Referring simultaneously to: Example B above; FIG. 1B; and FIGS. 5A, 5B, 5C and 5D, at 142 (FIG. 1B), method 130 checks whether or not the object detected in 141 contains formatting features, which are directly (hard) assigned to the object. If this is the case, a formatting element is defined at 145. FIG. 5A illustrates the case where the hard assigned formatting element “italics”, as set forth in 4.3 to 4.5 of EXAMPLE B, is detected at 142 and defined at 145 (FIG. 1B) as 501 in FIG. 5A. If, on the other hand, the result at 142 were NO, i.e., the object detected at 141 did not contain “italics”, as set forth in 4.3 to 4.5 of EXAMPLE B, then at 143, method 130 checks whether or not a formatting template is used for assigning the format to the object detected at 141. If the answer is YES, a formatting element corresponding to the formatting template is created at 144.

Method 130 proceeds to check whether a further formatting template is assigned to the object to be converted at 146 (FIG. 1B). If this is the case, the formatting template will form a parent formatting element in the XML-document (147). This instance is illustrated in FIG. 5B where the formatting template “text body” 502, as set forth in 4.0 to 4.2 of EXAMPLE B, is assigned and becomes a parent of element 501.

Method 130 then proceeds to check whether yet a further formatting template is assigned to the object to be converted at 146 (FIG. 1B). If this is the case, the formatting template will form a grandparent formatting element in the XML-document (147). This instance is illustrated in FIG. 5C where the formatting template “Standard” 503, as set forth in 4.0 of EXAMPLE B, is assigned and becomes a parent of the formatting template “text body” 502, as set forth in 4.0 to 4.2 of EXAMPLE B, and a grandparent of element 501.

As illustrated in FIG. 5D, according to one embodiment of method 130, the process performed at 146 and 147 (FIG. 1B) is subsequently repeated “N” times for each additional property of the current object, the formatting element generated at 147 then being a “N-2” parent formatting element 504.

As discussed above, when all formatting properties of the current object have been processed, the method 130 proceeds to 148 in which the formatting elements and parent formatting elements are arranged in the XML-document. Subsequently, at 149, the content data are arranged in the XML-document separate from the content elements. According to one embodiment of method 130, the order of performance of 148 and 149 is not important, i.e., the formatting elements can also be arranged in the XML-document after the content elements.

As also discussed above, at 150, it is determined whether the last object of the document to be converted has been processed or not. In the latter case, i.e., the last object of the document to be converted has not been processed, method 130 returns to 141 and detects the proceeding formatted object. Otherwise, the conversion operation is finished and the completed XML-document may be displayed on a display screen or stored in a suitable memory device.

According to one embodiment of method 130, a flag is inserted into a formatting element indicating that the formatting element is derived from a hard formatting property. The flag is then used to reconvert the formatting element into the hard formatted object in the original document format. The operation of providing this hard formatting flag may be carried out at 145 of the flow chart shown in FIG. 1B. In another embodiment of method 130, instead of inserting a flag into the formatting element, a hard formatting identifier is assigned to the formatting element, which is arranged at a different position in the XML-document (see 433 in FIG. 4).

The drawings and the forgoing description gave examples of the present invention. The scope of the present invention, however, is by no means limited by these specific examples. Numerous variations, whether explicitly given in the specification or not, such as differences in structure, dimension, and use of material, are possible.

For instance, the discussion above was directed, in large part, to embodiments of the invention where the mark-up document was an XML-document. However, those of skill in the art will recognize that, with little or no modification, other document types and file formats, such as Standard Generalized Mark-up Language (SGML) can be used with the method of the invention.

In addition, those skilled in the art will readily recognize that, in another embodiments of the present invention, method 130 may also be implemented by dedicated electronic circuits, which are configured such that they perform the individual operations explained above in connection with the method 130. In yet another embodiment of the invention, a storage medium has thereon installed computer-executable program code, which causes processors, such as processors 101 or 182 in FIG. 1A, to perform the operations of method 130 explained above.

In addition, method 130 can be executed on a hardware configuration like a personal computer or workstation as illustrated schematically in FIG. 1A by computer system 100. Method 130, however, may also be applied to a client-server configuration 150 that also is illustrated in FIG. 1A. In this embodiment, some or all operations of method 130 are carried out on a server computer accessible by the client device over a data network, or networks, such as the Internet, using a browser application or the like.

Herein, a computer program product comprises a medium configured to store or transport computer readable code for method 130 or in which computer readable code for method 130 is stored. As illustrated in FIG. 1A, this storage medium may belong to computer system 100 itself. However, the storage medium also may be removed from computer system 100. For example, method 130 may be stored in memory 184 that is physically located in a location different from processor 101. The only requirement is that processor 101 is coupled to the memory containing method 130. This could be accomplished in a client-server system 150, e.g. computer system 100 is the client and server system 180 is the server, or alternatively via a connection to another computer via modems and analog lines, or digital interfaces and a digital carrier line.

For example, memory 184 could be in a World Wide Web portal, while display unit 116 and processor 101 are in a personal digital assistant (PDA), or a wireless telephone, for example. Conversely, the display unit and at least one of the input devices could be in a client computer, a wireless telephone, or a PDA, while the memory and processor are part of a server computer on a wide area network, a local area network, or the Internet.

More specifically, computer system 100, in one embodiment, can be a portable computer, a workstation, a two-way pager, a cellular telephone, a digital wireless telephone, a personal digital assistant, a server computer, an Internet appliance, or any other device that includes the components shown and that can execute method 130, or at least can provide the input instructions to method 130 that is executed on another system. Similarly, in another embodiment, computer system 100 can be comprised of multiple different computers, wireless devices, cellular telephones, digital telephones, two-way pagers, or personal digital assistants, server computers, or any desired combination of these devices that are interconnected to perform method 130, as described herein.

Herein, a computer memory refers to a volatile memory, a non-volatile memory, or a combination of the two in any one of these devices. Similarly, a computer input unit and a display unit refer to the features providing the required functionality to input the information described herein, and to display the information described herein, respectively, in any one of the aforementioned or equivalent devices.

Consequently, in view of this disclosure, those of skill in the art will recognize that method 130 can be implemented in a wide variety of computer system configurations. In addition, method 130 could be stored as different modules in memories of different devices. For example, method 130 could initially be stored in a server computer, and then as necessary, a module of method 130 could be transferred to a client device and executed on the client device. Consequently, part of method 130 would be executed on server processor 182, and another part of method 130 would be executed on processor 101 of computer system 100. In view of this disclosure, those of skill in the art can implement the invention on a wide-variety of physical hardware configurations using an operating system and computer programming language of interest to the user. For example, FIG. 1A shows input devices 119 and 118, but other input devices, such as speech recognition software and/or hardware could be used to input the selections and data for method 130.

In yet another embodiment, method 130 is stored in memory 184 of system 180. Stored method 130 is transferred, over network 104 to memory 111 in computer system 100. In one embodiment, network interface 183 and I/O interface 102 would include analog modems, digital modems, or a network interface card. If modems are used, network 104 includes a communications network, and method 130 is downloaded via the communications network.

Those of skill in the art will also recognize that method 130 may be implemented in a computer program including a comprehensive STAROFFICE office application that is available from Sun Microsystems, Inc. of Palo Alto, Calif. (STAROFFICE is a trademark of Sun Microsystems.) Such a computer program may be stored on any common data carrier like, for example, a floppy disk or a compact disc (CD), as well as on any common computer system's storage facilities like hard disks. Therefore, one embodiment of the present invention also relates to a data carrier for storing a computer program for carrying out the inventive method. Another embodiment of the present invention also relates to a method for using a computer system for carrying out the presented inventive method. Yet another embodiment of the present invention further relates to a computer system with a storage medium on which a computer program for carrying out the presented inventive method is stored.

Therefore, while the present invention has been explained in connection with various specific embodiments thereof, those skilled in the art will readily recognize that modifications can be made to this embodiment without departing from the spirit and scope of the present invention. Consequently, the scope of the invention is at least as broad as given by the following claims.

What is claimed is:

1. A method for separating content and layout of formatted data objects to convert a computer readable document into a structured mark-up document, the method comprising:
separating content data and formatting data; and
arranging the content data and the formatting data in separate elements of the structured mark-up document.

2. The method of claim 1, wherein;
the structured mark-up document is an XML-document.

3. The method of claim 2, wherein;
one formatting element of the XML-document is referenced by a plurality of content elements and/or formatting elements of the XML-document.

4. The method of claim 3, wherein;
the formatted objects of the computer readable document include pages, paragraphs, text portions, images, tables, drawing, mathematical formula and other formatted objects.

5. The method of claim 3, further comprising:
assigning a hard formatting identifier to a formatting element representing first formatting data.

6. The method of claim 2, wherein;
the computer readable document contains first formatting data, which are directly assigned to a formatted object, and second formatting data contained in a separate formatting template, and further comprising:
in the XML-document, arranging the first formatting data in a formatting element and the second formatting data in a parent formatting element, wherein;
the formatting element comprises a reference to the parent formatting element.

7. The method of claim 6, wherein;
one formatting element of the XML-document is referenced by a plurality of content elements and/or formatting elements of the XML-document.

8. The method of claim 6, further comprising:
assigning a hard formatting identifier to a formatting element representing first formatting data.

9. The method of claim 6, wherein;
the formatted objects of the computer readable document include pages, paragraphs, text portions, images, tables, drawing, mathematical formula and other formatted objects.

10. The method of claim 9, further comprising:
assigning a hard formatting identifier to a formatting element representing first formatting data.

11. A computer system for separating content and layout of formatted data objects to convert a computer readable document into a an XML-document, comprising:
program code separating the content data and formatting data; and
means for arranging the content data as content elements and the formatting data as formatting elements in the XML-document.

12. The computer system of claim 11, wherein;
the computer readable document contains first formatting data which are directly assigned to a formatted object and second formatting data contained in a separate formatting template, further wherein, in the XML-document;
the first formatting data are arranged in a formatting element and the second formatting data are arranged in a parent formatting element, further wherein;
the formatting element comprises a reference to the parent formatting element.

13. The computer system of claim 12, wherein;
one formatting element of the XML-document is referenced by a plurality of content elements and/or formatting elements of the XML-document.

14. The computer system of claim 12, wherein;
the formatted objects of the computer readable document include pages, paragraphs, text portions, images, tables, drawing, mathematical formula and other formatted objects.

15. The computer system of claim 11, wherein;
one formatting element of the XML-document is referenced by a plurality of content elements and/or formatting elements of the XML-document.

16. The computer system of claim 15, wherein;
the formatted objects of the computer readable document include pages, paragraphs, text portions, images, tables, drawing, mathematical formula and other formatted objects.

17. A computer program for separating content and layout of formatted data objects to convert a computer readable document into a structured mark-up document, the program comprising:
program code adapted for separating content data and formatting data; and
program code adapted for arranging the content data and the formatting data in separate elements of the structured mark-up document.

18. The computer program of claim 17, wherein;
the structured mark-up document is an XML-document.

19. The computer program of claim 18, wherein;
one formatting element of the XML-document is referenced by a plurality of content elements and/or formatting elements of the XML-document.

20. The computer program of claim 19, further comprising:
program code adapted for inserting a hard formatting flag into a formatting element of the XML-document representing first formatting data of the original document to be converted.

21. The computer program of claim 18, wherein;
the computer readable document contains first formatting data which are directly assigned to a formatted object and second formatting data contained in a separate formatting template, the computer program further comprising;
program code adapted for, in the XML-document, arranging the first formatting data in a formatting element and the second formatting data in a parent formatting element, wherein;
the formatting element comprises a reference to the parent formatting element.

22. The computer program of claim 21, wherein;
one formatting element of the XML-document is referenced by a plurality of content elements and/or formatting elements of the XML-document.

23. The computer program of claim 21, comprising program code adapted for inserting a hard formatting flag into a formatting element of the XML-document representing first formatting data of the original document to be converted.

24. A stored data structure for separating content and layout of formatted data objects to convert a computer readable document into an XML-document, the stored data structure comprising:
program code adapted for separating content data and formatting data; and
program code adapted for arranging the content data and the formatting data in separate elements of the XML-document.

25. A stored data structure comprising a method for separating content and layout of formatted data objects, said method comprising:
converting a computer readable document into:
first data elements in a mark-up code containing content data;
second data elements in a mark-up code containing formatting data obtained by converting formatting data contained in a formatting template of a computer readable document; and
third data elements in a mark-up code containing formatting data obtained by converting formatting data directly assigned to objects contained in the computer readable document.

26. The stored data structure of claim 25, wherein;
the mark-up code is XML code.

27. The stored data structure of claim 25, wherein;
the third data elements contain hard formatting flags.

28. The stored data structure of claim 27, wherein;
the mark-up code is XML code.

29. A method of for separating content and layout of formatted data objects to convert a computer readable document into a XML-document, the method comprising:
separating content data and formatting data; and
arranging the content data and the formatting data in separate elements of the structured mark-up document, wherein;
one formatting element of the XML-document is referenced by a plurality of content elements and/or formatting elements of the XML-document.

30. A method for separating content and layout of formatted data objects to convert a computer readable document into a XML-document, the method comprising:
separating content data and formatting data;
arranging the content data and the formatting data in separate elements of the structured mark-up document, wherein;
the computer readable document contains first formatting data, which are directly assigned to a formatted object, and second formatting data contained in a separate formatting template; and
in the XML-document, arranging the first formatting data in a formatting element and the second formatting data in a parent formatting element, wherein;
the formatting element comprises a reference to the parent formatting element.

31. A method for separating content and layout of formatted data objects to convert a computer readable document into a structured mark-up document into a XML-document, the method comprising:
separating content data and formatting data;
arranging the content data and the formatting data in separate elements of the structured mark-up document; and
assigning a hard formatting identifier to a formatting element representing first formatting data, wherein;
one formatting element of the XML-document is referenced by a plurality of content elements and/or formatting elements of the XML-document.

32. A method for separating content and layout of formatted data objects to convert a computer readable document into a structured mark-up document into a XML-document, the method comprising:
separating content data and formatting data; and
arranging the content data and the formatting data in separate elements of the structured mark-up document, wherein;
the computer readable document contains first formatting data, which are directly assigned to a formatted object, and second formatting data contained in a separate formatting template;
in the XML-document, arranging the first formatting data in a formatting element and the second formatting data in a parent formatting element, wherein;
the formatting element comprises a reference to the parent formatting element, further wherein;
one formatting element of the XML-document is referenced by a plurality of content elements and/or formatting elements of the XML-document; and
assigning a hard formatting identifier to a formatting element representing first formatting data.
